(19) United States
(12) Patent Application Publication
(10) Pub. No.: US 2025/0181098 A1
(43) Pub. Date: Jun. 5, 2025

(54) BANDGAP REFERENCE VOLTAGE GENERATOR SUITABLE FOR LOW SUPPLY VOLTAGE

(71) Applicant: MEDIATEK INC., Hsinchu City (TW)

(72) Inventor: Sung-En Hsieh, Hsinchu City (TW)

(73) Assignee: MEDIATEK INC., Hsinchu City (TW)

(21) Appl. No.: 18/963,820

(22) Filed: Nov. 29, 2024

Related U.S. Application Data
(60) Provisional application No. 63/604,228, filed on Nov. 30, 2023.

(51) Int. Cl. G05F 3/24

(52) U.S. Cl. CPC G05F 3/245

(57) ABSTRACT

The present invention provides a bandgap reference voltage generator, which includes a first transistor, a second transistor, a third transistor and a fourth transistor. A source electrode of the first transistor is coupled to a ground voltage via at least a first resistor. A source electrode of the second transistor is coupled to the ground voltage, and a gate electrode of the second transistor is coupled to a gate electrode of the first transistor. The third transistor is coupled between the first resistor and a supply voltage. The fourth transistor is coupled to the second transistor via a second resistor. The bandgap reference voltage generator generates a reference voltage at the drain electrode of fourth transistor; and a size of the first transistor is greater than a size of the second transistor, or a size of the third transistor is smaller than a size of the fourth transistor.

### CROSS REFERENCE TO RELATED APPLICATIONS

This application claims the benefit of U.S. Provisional Application No. 63/604,228, filed on Nov. 30, 2023. The content of the application is incorporated herein by reference.

### BACKGROUND

Bandgap reference voltage circuits are widely used in integrated circuits to generate a reference voltage that is unaffected by temperature. Current bandgap reference voltage circuits typically consist of two bipolar junction transistors (BJTs) and other circuit components to generate a proportional-to-absolute temperature (PTAT) voltage and a complementary-to-absolute temperature (CTAT) voltage. These two voltages are then combined to generate a temperature-independent reference voltage.

However, with the evolution of semiconductor processes, the size of transistors has become smaller, and their breakdown voltages have decreased. Consequently, the supply voltage for chips also needs to be designed to be very low, potentially below 1 volt. Nevertheless, since BJTs require a base-emitter voltage of about 0.7V, it becomes increasingly challenging to design them in bandgap reference voltage circuits when the supply voltage is very low, and they may even become impossible to implement.

### SUMMARY

One of the objectives of this invention is to propose a bandgap reference voltage circuit that can generate a temperature-independent reference voltage without the need for any BJT, to address the issues described in the prior art.

According to one embodiment of the present invention, a bandgap reference voltage generator is disclosed. The bandgap reference voltage generator comprises a first transistor, a second transistor, a third transistor and a fourth transistor. A source electrode of the first transistor is coupled to a ground voltage via at least a first resistor. A source electrode of the second transistor is coupled to the ground voltage, and a gate electrode of the second transistor is coupled to a gate electrode of the first transistor. A source electrode of the third transistor is coupled to a supply voltage, and a drain electrode of the third transistor is coupled to a drain electrode of the first transistor. A source electrode of the fourth transistor is coupled to the supply voltage, and a drain electrode of the fourth transistor is coupled to a drain electrode of the second transistor via a second resistor. In addition, the bandgap reference voltage generator generates a reference voltage at the drain electrode of fourth transistor; and a size of the first transistor is greater than a size of the second transistor; or a size of the third transistor is smaller than a size of the fourth transistor.

According to one embodiment of the present invention, a bandgap reference voltage generator is disclosed. The bandgap reference voltage generator comprises a first transistor, a second transistor, a third transistor and a fourth transistor. A source electrode of the first transistor is coupled to a ground voltage via at least a first resistor. A source electrode of the second transistor is coupled to the ground voltage, and a gate electrode of the second transistor is coupled to a gate electrode of the first transistor. A source electrode of the third transistor is coupled to a supply voltage, and a drain electrode of the third transistor is coupled to a drain electrode of the first transistor. A source electrode of the fourth transistor is coupled to the supply voltage, and a drain electrode of the fourth transistor is coupled to a drain electrode of the second transistor. In addition, the bandgap reference voltage generator further comprises a second resistor and a third resistor, wherein the second resistor is coupled between the first resistor and the ground voltage, and third resistor is coupled between the source electrode of the second transistor and the ground voltage. In addition, the bandgap reference voltage generator generates a reference voltage at the drain electrode of fourth transistor; and a size of the first transistor is greater than a size of the second transistor; or a size of the third transistor is smaller than a size of the fourth transistor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a bandgap reference voltage generator according to one embodiment of the present invention.

FIG. 2 shows a diagram of combining a PTAT voltage and a CTAT voltage to obtain a temperature-independent reference voltage.

FIG. 3 is a diagram illustrating a bandgap reference voltage generator according to one embodiment of the present invention.

FIG. 4 is a diagram illustrating a bandgap reference voltage generator according to one embodiment of the present invention.

FIG. 5 is a diagram illustrating a bandgap reference voltage generator according to one embodiment of the present invention.

FIG. 6 is a diagram illustrating a bandgap reference voltage generator according to one embodiment of the present invention.

FIG. 7 is a diagram illustrating a buffer within the bandgap reference voltage generator according to one embodiment of the present invention.

FIG. 8 is a diagram illustrating controlling a signal outputted by the operational amplifier within the buffer according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

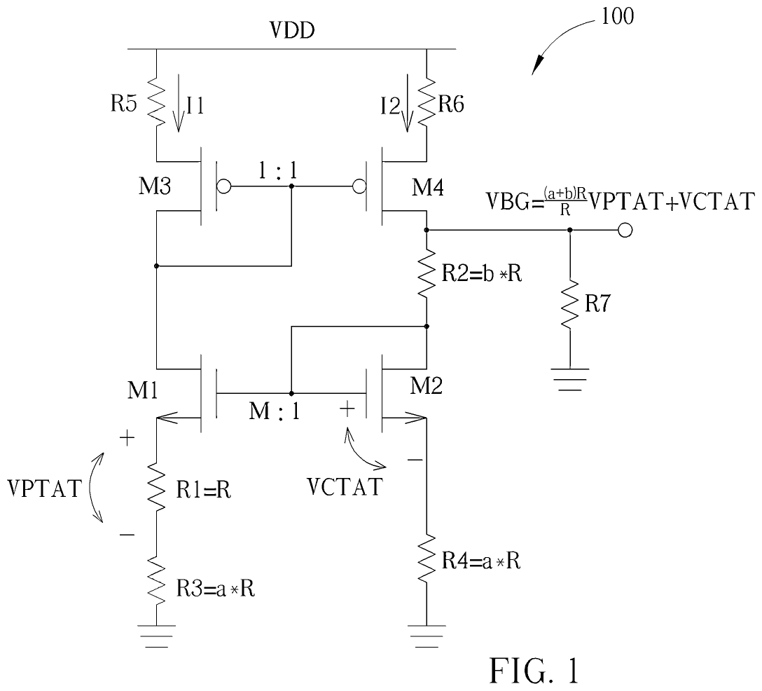

FIG. 1 is a diagram illustrating a bandgap reference voltage generator 100 according to one embodiment of the present invention. As shown in FIG. 1, the bandgap reference voltage generator 100 comprises a transistors M1-M4 and resistors R1-R7. In this embodiment, the transistors M1 and M2 are N-type Metal Oxide Semiconductor Field Effect Transistor (MOSFET), and the transistors M3 and M4 are P-type MOSFETs. A source electrode of the transistor M1 is coupled to a ground voltage via the resistors R1 and R3 that are connected in series, a gate electrode of the transistor M1 is connected to a gate electrode of the transistor M2, and a drain electrode of the transistor M1 is coupled to a drain electrode of the transistor M3. A source electrode of the transistor M2 is coupled to the ground voltage via the resistor R4, and a drain electrode of the transistor M2 is coupled to a drain electrode of the transistor M4 via the resistor R2. A source electrode of the transistor M3 is coupled to a supply voltage VDD via the resistor R5, and a gate electrode of the transistor M3 is coupled to a gate electrode of the transistor M4. A source electrode of the transistor M4 is coupled to the supply voltage VDD via the resistor R6, and the drain electrode of the transistor M4 serves as an output terminal of the bandgap reference voltage generator 100, for generating a reference voltage VBG. In addition, the resistor R7 is coupled between the ground voltage and the output terminal of the bandgap reference voltage generator 100.

In FIG. 1, the transistors M3 and M4 form a current mirror, and a ratio between a current I1 flowing through the transistor M3 and a current I2 flowing through the transistor M4 is determined based on the sizes of the transistors M3 and M4. For convenience of description, the transistors M3 and M4 have the same size, and the currents I1 and 12 are the same. In addition, the size of transistor M1 is different from the size of transistor M2, and in this example, the size of transistor M1 is M times the size of the transistor M2, that is the channel width of the transistor M1 is M times that of the transistor M2, wherein “M” is greater than “1”.

In the embodiment shown in FIG. 1, the current flowing through the transistor M2 is given by the following equation (1):

$$I 2 = I 0 * \frac{W}{L} * exp ( \frac{{V}_{g s} - {V}_{t h}}{η * {V}_{T}} ) . \qquad ( 1 )$$

The current flowing through the transistor M1 is described by equation (2):

$$I 1 = I 0 * \frac{M * W}{L} * exp ( \frac{{V}_{g s} - {V}_{t h} - V PTAT}{η * {V}_{T}} ) . \qquad ( 2 )$$

In the equations (1) and (2), the following parameters are defined: “10” is a saturation current, “W” is the channel width of the transistor M2, “L” is the channel length of the transistors M1 and M2, “Vgs” is a gate-source voltage of the transistor M2, “Vth” is a threshold voltage of the transistors M1 and M2, “VPTAT” is a cross voltage of the resistor R1 (which is a proportional-to-absolute temperature voltage), “n” is an ideality factor, and “Vr” is a thermal voltage. In this embodiment, because the currents I1 and 12 are the same, the PTAT voltage “VPTAT” can be expressed as follows:

$$V PTAT = η * {V}_{T} * ln ( M ) . \qquad ( 3 )$$

In light of above, it can be observed that the PTAT voltage VPTAT is irrelevant to the semiconductor parameters such as the gate-source voltage and the threshold voltage of the transistor M1. As a result, the PTAT voltage VPTAT is insensitive to variations in the semiconductor process and supply voltage.

In this embodiment, the resistance of the resistors R1-R4 are designed as “R”, “b*R”, “a*R” and “a*R”, wherein “a” and “b” are positive constants that can take any suitable values. In addition, because the current I1, which is the same as I2, can also be expressed as (VPTAT/R), and the threshold voltage of the transistor M2 can be inherently considered as a CTAT voltage VCTAT, the reference voltage VBG generated at the drain electrode of the transistor M4 can be represented as follows:

$$V BG = \frac{( a + b ) * R}{R} * V PTAT + V CTAT . \qquad ( 4 )$$

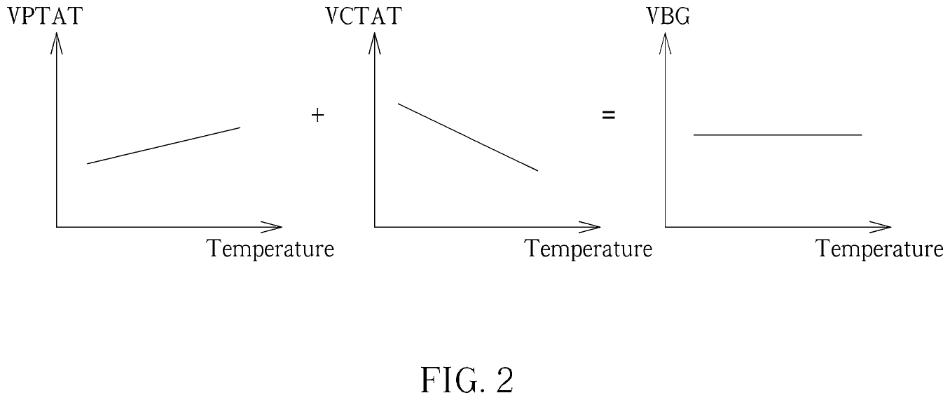

Referring to FIG. 2 together, as temperature increases, the PTAT voltage VPTAT increases while the CTAT voltage VCTAT decreases. Therefore, by appropriately selecting the values of “a” and “b”, the bandgap reference voltage generator 100 can generate a temperature-independent reference voltage VBG.

In the embodiment shown in FIG. 1, since the bandgap reference voltage generator 100 does not have any BJT, this circuit can be used with a very low supply voltage VDD.

It is noted that the resistor R7 in the embodiment of FIG. 1 is for lowering and stabilizing the DC level of the reference voltage VBG. In another embodiment, the resistor R7 can be removed from the bandgap reference voltage generator 100.

In the above embodiment, the currents I1 and 12 are designed to be the same, and the size of transistor M1 is greater than the size of the transistor M2. However, this configuration is not a limitation of the present invention. In an alternative embodiment, the same reference voltage VBG can be obtained if the transistor M1 and the transistor M2 have the same size, with the current I1 being (1/M) times the current I2. This alternative design should fall within the scope of the present invention.

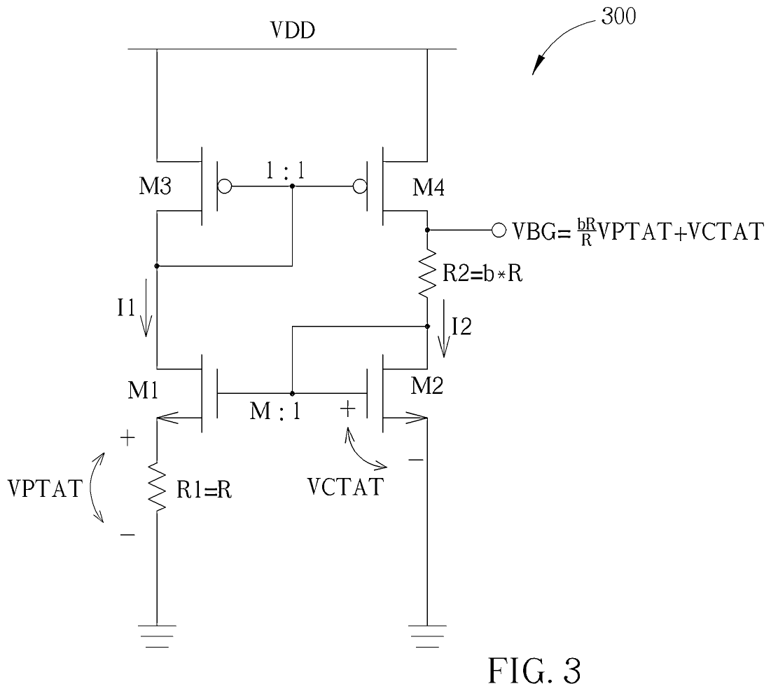

In the embodiment shown in FIG. 1, the resistors R3-R6 serve as source degeneration circuit for impedance matching and better linearity, and the resistors R3-R6 may be removed from the bandgap reference voltage generator 100. Specifically, referring to FIG. 3, which is a diagram illustrating a bandgap reference voltage generator 300 according to one embodiment of the present invention. As shown in FIG. 3, the bandgap reference voltage generator 300 comprises the transistors M1-M4 and resistors R1, R2. In this embodiment, the transistors M1 and M2 are N-type MOSFET, and the transistors M3 and M4 are P-type MOSFETs.

Similar to the embodiment shown in FIG. 1, the current I2 flowing through the transistor M2 is described by equation (1), the current I1 flowing through the transistor M1 is described by equation (2), and the PTAT voltage (i.e., the cross voltage of the resistor R1) is given by equation (3). In this embodiment, the resistance of the resistors R1 and R2 are designed as “R” and “b*R”, wherein “b” can be any suitable positive value. In addition, because the current I1, which is the same as I2, can also be expressed as (VPTAT/R), and the threshold voltage of the transistor M2 can be inherently considered as a CTAT voltage VCTAT, the reference voltage VBG generated at the drain electrode of the transistor M4 can be represented as follows:

$$V BG = \frac{b * R}{R} * V PTAT + V CTAT . \qquad ( 5 )$$

Referring to FIG. 2 together, by designing the suitable value “b”, the bandgap reference voltage generator 300 can generate the temperature-independent reference voltage VBG.

In an alternative embodiment, a resistor, such as the resistor R7 shown in FIG. 1, can be positioned between the ground voltage and the output terminal of the bandgap reference voltage generator 300, to lower and stabilize the reference voltage VBG.

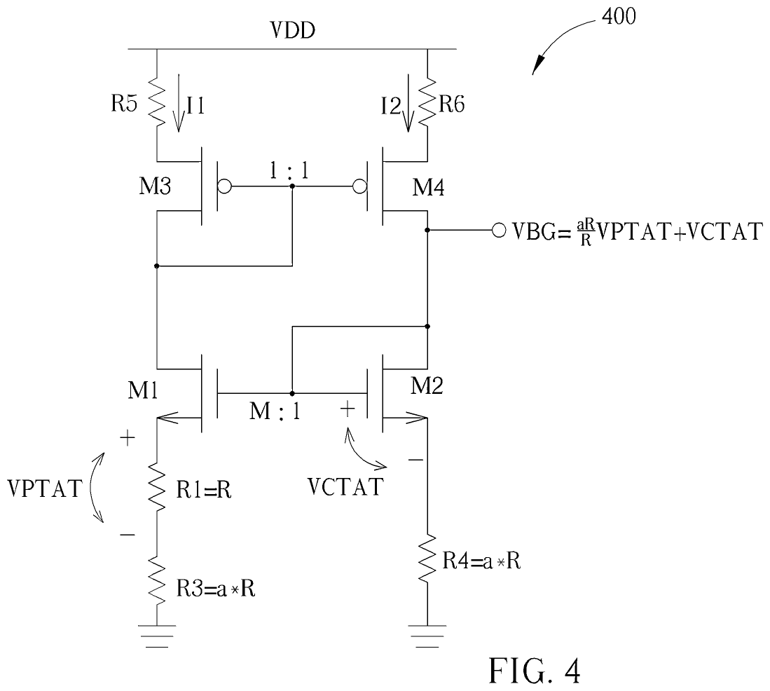

FIG. 4 is a diagram illustrating a bandgap reference voltage generator 400 according to one embodiment of the present invention. As shown in FIG. 4, the bandgap reference voltage generator 400 comprises the transistors M1-M4 and resistors R1 and R3-R6. In this embodiment, the transistors M1 and M2 are N-type MOSFET, and the transistors M3 and M4 are P-type MOSFETs. Similar to the embodiment shown in FIG. 1, the current I2 flowing through the transistor M2 is described equation (1), the current I1 flowing through the transistor M1 is described by equation (2), and the PTAT voltage (i.e., the cross voltage of the resistor R1) is given by equation (3). In this embodiment, the resistance of the resistors R1, R3 and R4 are designed as “R”, “a*R” and “a*R”, wherein “a” can be any suitable positive value. In addition, because the current I1, which is the same as I2, can also be expressed as (VPTAT/R), and the threshold voltage of the transistor M2 can be inherently considered as a CTAT voltage VCTAT, the reference voltage VBG generated at the drain electrode of the transistor M4 can be represented as follows:

$$V BG = \frac{a * R}{R} * V PTAT + V CTAT . \qquad ( 5 )$$

Referring to FIG. 2 together, by designing the suitable value “a”, the bandgap reference voltage generator 400 can generate the temperature-independent reference voltage VBG.

In an alternative embodiment, a resistor, such as the resistor R7 shown in FIG. 1, can be positioned between the ground voltage and the output terminal of the bandgap reference voltage generator 400, to lower and stabilize the reference voltage VBG.

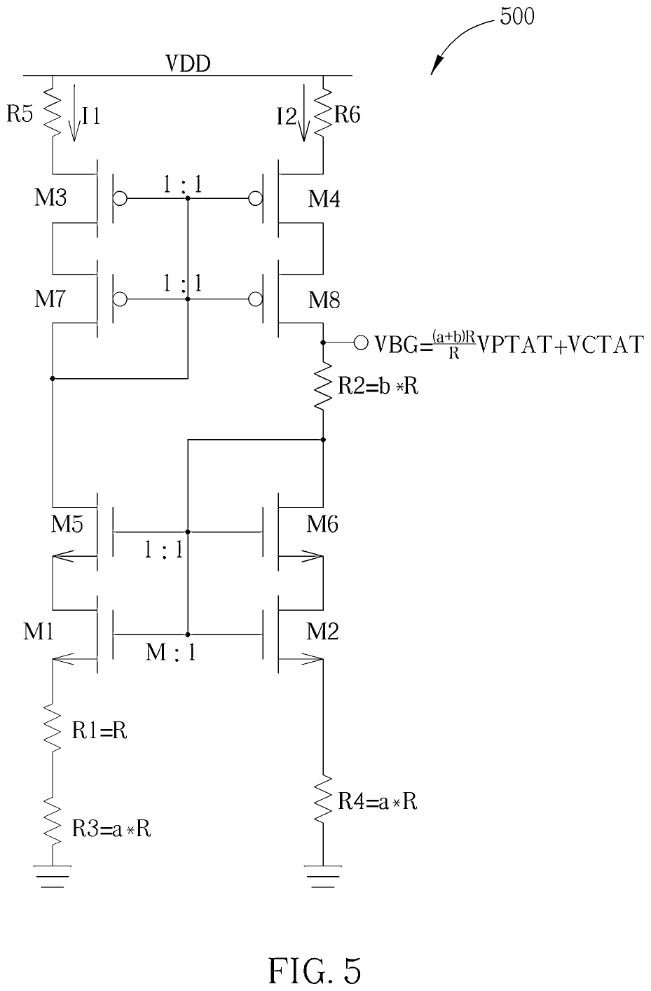

FIG. 5 is a diagram illustrating a bandgap reference voltage generator 500 according to one embodiment of the present invention. As shown in FIG. 5, the bandgap reference voltage generator 100 comprises a transistors M1-M8 and resistors R1-R6. In this embodiment, the transistors M1, M2, M5 and M6 are N-type MOSFETS, and the transistors M3, M4, M7 and M8 are P-type MOSFETs. A source electrode of the transistor M1 is coupled to a ground voltage via the resistors R1 and R3 that are connected in series, a gate electrode of the transistor M1 is connected to a gate electrode of the transistor M2, and a drain electrode of the transistor M1 is coupled to a drain electrode of the transistor M5. A source electrode of the transistor M2 is coupled to the ground voltage via the resistor R4, and a drain electrode of the transistor M2 is coupled to a drain electrode of the transistor M6. A drain electrode of the transistor M5 is coupled to a drain electrode of the transistor M7, and a gate electrode of the transistor M5 is coupled to a gate electrode of the transistor M6. A drain electrode of the transistor M6 is coupled to a drain electrode of the transistor M8 via the resistor R2. A source electrode of the transistor M3 is coupled to a supply voltage VDD via the resistor R5, a drain electrode of the transistor M3 is coupled to a source electrode of the transistor M7, and a gate electrode of the transistor M3 is coupled to a gate electrode of the transistor M4. A source electrode of the transistor M4 is coupled to the supply voltage VDD via the resistor R6, and a drain electrode of the transistor M4 is coupled to a source electrode of the transistor M8. A gate electrode of the transistor M7 is coupled to a gate electrode of the transistor M8, and the drain electrode of the transistor M8 serves as an output terminal of the bandgap reference voltage generator 500, for generating a reference voltage VBG.

In this embodiment, the transistors M1-M4 are manufactured with standard threshold voltage (i.e., commonly referred to as SVT device), and the transistors M5-M8 are designed with the ultra-low threshold voltage (i.e., commonly referred to as ULVT device).

The main operation of the bandgap reference voltage generator 500 is generally similar to the embodiment shown in FIG. 1. The difference lies in that the embodiment of FIG. 5 additionally includes four transistors M5-M8, which are used to stabilize the current flowing through the transistors M1 to M4. Taking the transistors M2 and M6 as an example, by designing the transistors M2 and M6 in cascaded, the voltage at the drain electrode of the transistor M4 will equal to: Vs+Vth_svt−Vth_ulvt, wherein “Vs” is the voltage at the source electrode of the transistor M2, “Vth_svt” is the threshold voltage of the transistor M2, and “Vth_ulvt” is the threshold voltage of the transistor M6. Because the difference between the “Vth_svt” and “Vth_ulvt” is almost constant across different temperatures, the current flowing through transistor M2 can be controlled to a fixed value. As a result, the bandgap reference voltage generator 500 can generate a more accurate and stable reference voltage VBG.

In an alternative embodiment, a resistor, such as the resistor R7 shown in FIG. 1, can be positioned between the ground voltage and the output terminal of the bandgap reference voltage generator 500, to lower and stabilize the reference voltage VBG.

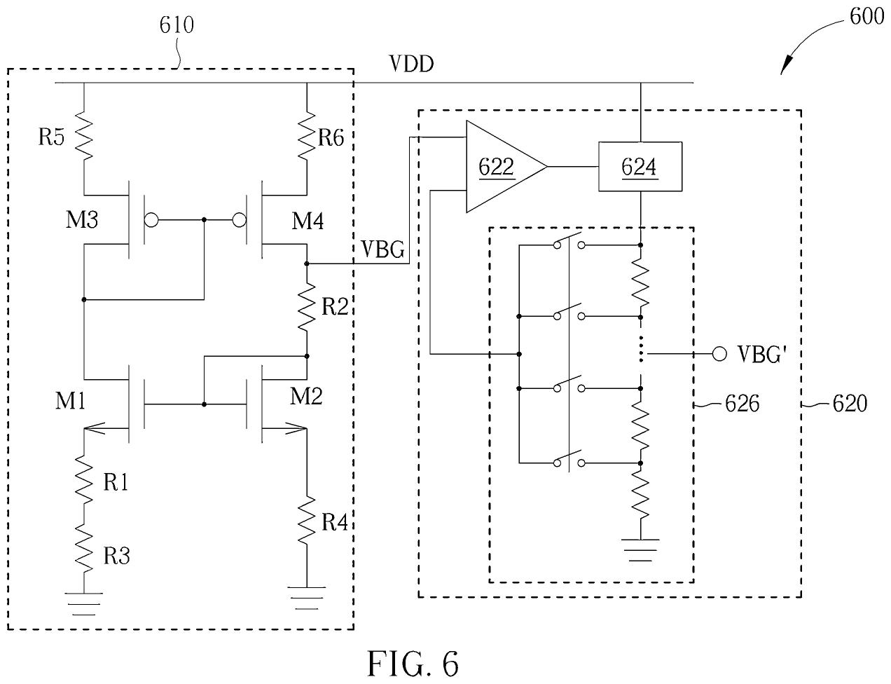

FIG. 6 is a diagram illustrating a bandgap reference voltage generator 600 according to one embodiment of the present invention. As shown in FIG. 6, the bandgap reference voltage generator 600 comprises core circuit 610 and a buffer 620, wherein the core circuit 610 is the same as the bandgap reference voltage generator 100 shown in FIG. 1, and the buffer 620 comprises an operational amplifier 622, a transistor 624 serving as a switch, and a trimming circuit 626. In this embodiment, the core circuit 610 is configured to generate the temperature-independent reference voltage VBG, however, due to the variation of the semiconductor process, the temperature-independent reference voltage VBG may not have the desired voltage level. For example, when the process corner of the core circuit 610 belongs to a fast-fast (FF) corner, the reference voltage VBG may have a lower voltage level; and when the process corner of the core circuit 610 belongs to a slow-slow (SS) corner, the reference voltage VBG may have a higher voltage level. In order to solve this problem, the buffer 620 is configured to adjust the voltage level of the reference voltage VBG to generate an adjusted reference voltage VBG′.

Specifically, the operational amplifier 622 receives the reference voltage VBG at one input terminal to generate an amplified signal to control the transistor 624, and the other input terminal of the operational amplifier 622, which is connected to an input terminal of the trimming circuit 626, is forced to have the voltage level equal to the reference voltage VBG. In addition, the trimming circuit 626 has multiple switches and multiple resistors, and the engineer may enable different switches to determine which switch should be enabled to obtain the adjusted reference voltage VBG′ with the desired voltage level.

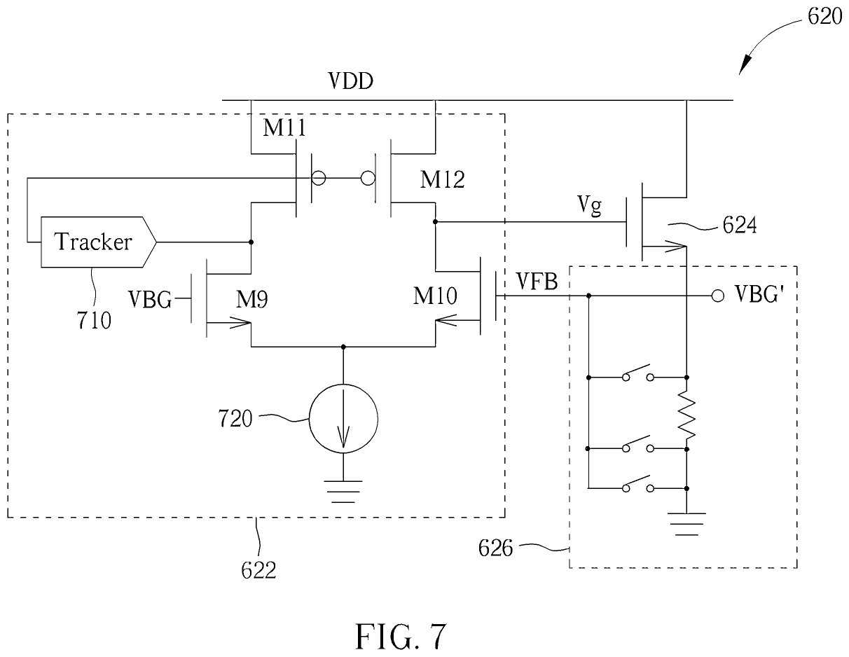

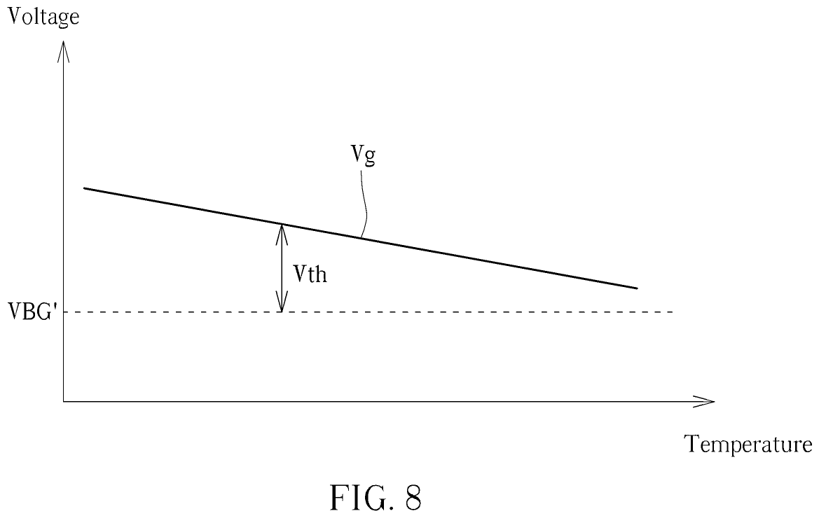

FIG. 7 is a diagram illustrating the buffer 620 according to one embodiment of the present invention. As shown in FIG. 7, the transistor 624 is implemented by using the N-type MOSFET, to have the better power supply rejection ratio (PSRR), driving ability and stability. The operational amplifier 622 comprises four transistors M9-M12, a tracker 710 and a current source 720. In this embodiment, the transistors M9 and M10 are N-type MOSFETs, and the transistors M11 and M12 are P-type MOSFETs. The transistors M9 and M10 receive the reference voltage VBG and a feedback signal VFB (i.e. the adjusted reference voltage VBG′) at the gate electrodes, the source electrodes of the transistors M9 and M10 are connected to the current source 720, and the drain electrodes of the transistors M9 and M10 are coupled to drain electrodes of the transistors M11 and M12. The source electrodes of the transistors M11 and M12 are coupled to the supply voltage VDD, the gate electrodes of the transistors M11 and 12 are connected to each other, and the drain electrode of the transistor M12 serves as an output terminal of the operational amplifier 622. In addition, the tracker 710 is coupled between the gate electrode and the drain electrode of the transistor M11, to control the signal Vg so that it has the relationship between temperature and voltage level shown in FIG. 8.

In the embodiment shown in FIG. 7 and FIG. 8, because the threshold voltage (Vth) of the transistor 624 is a CTAT voltage, by controlling the signal Vg shown in FIG. 8, the adjusted reference voltage VBG′ will be more stable. In addition, the tracker 710 can be considered as a reference voltage and threshold voltage tracking circuit, and the tracker 710 can control the output terminal of the transistor M12 to have the voltage level similar to the signal Vg if the connection between the operational amplifier 622 and transistor 624 is broken, so that the operational amplifier 622 and transistor 624 have almost no gain error.

Briefly summarized, in the present invention, the bandgap reference voltage generator only needs to use four transistors and several resistors to accurately generate the temperature-independent reference voltage, so the manufacturing cost can be effectively reduced. In addition, the bandgap reference voltage generator of the present invention does not have any BJT, this circuit can be used with a very low supply voltage.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A bandgap reference voltage generator, comprising:
a first transistor, wherein a source electrode of the first transistor is coupled to a ground voltage via at least a first resistor;
a second transistor, wherein a source electrode of the second transistor is coupled to the ground voltage, and a gate electrode of the second transistor is coupled to a gate electrode of the first transistor;
a third transistor, wherein a source electrode of the third transistor is coupled to a supply voltage, and a drain electrode of the third transistor is coupled to a drain electrode of the first transistor; and
a fourth transistor, wherein a source electrode of the fourth transistor is coupled to the supply voltage, and a drain electrode of the fourth transistor is coupled to a drain electrode of the second transistor via a second resistor;
wherein the bandgap reference voltage generator generates a reference voltage at the drain electrode of fourth transistor; and a size of the first transistor is greater than a size of the second transistor; or a size of the third transistor is smaller than a size of the fourth transistor.

2. The bandgap reference voltage generator of claim 1, further comprising:
a third resistor, coupled between the first resistor and the ground voltage;
a fourth resistor, coupled between the source electrode of the second transistor and the ground voltage;
a fifth resistor, coupled between the source electrode of the third transistor and the supply voltage; and
a sixth resistor, coupled between the source electrode of the fourth transistor and the supply voltage.

3. The bandgap reference voltage generator of claim 2, wherein resistance of the first resistor combined with the third resistor is greater than resistance of the fourth resistor.

4. The bandgap reference voltage generator of claim 1, wherein the first transistor and the second transistor are N-type Metal Oxide Semiconductor Field Effect Transistors (MOSFETs), and the third transistor and the fourth transistor are P-type MOSFET.

5. The bandgap reference voltage generator of claim 1, further comprising:
a buffer, configured to receive the reference voltage to generate an adjusted reference voltage, and the buffer comprises:
an operational amplifier, wherein a first input terminal is used to receive the reference voltage;
a trimming circuit, wherein an input terminal of the trimming circuit is connected to a second input terminal of the operational amplifier, and the trimming circuit is configured to generate adjusted reference voltage; and
a transistor, controlled by a signal outputted by the operational amplifier, to selectively connecting the supply voltage to the trimming circuit.

6. The bandgap reference voltage generator of claim 5, wherein the operational amplifier further comprises a tracker, and the tracker is configured to control the signal outputted by the operational amplifier to be a complementary-to-absolute temperature (CTAT) voltage.

7. A bandgap reference voltage generator, comprising:
a first transistor, wherein a source electrode of the first transistor is coupled to a ground voltage via at least a first resistor;
a second transistor, wherein a source electrode of the second transistor is coupled to the ground voltage, and a gate electrode of the second transistor is coupled to a gate electrode of the first transistor;
a third transistor, wherein a source electrode of the third transistor is coupled to a supply voltage, and a drain electrode of the third transistor is coupled to a drain electrode of the first transistor; and
a fourth transistor, wherein a source electrode of the fourth transistor is coupled to the supply voltage, and a drain electrode of the fourth transistor is coupled to a drain electrode of the second transistor;
a second resistor, coupled between the first resistor and the ground voltage;
a third resistor, coupled between the source electrode of the second transistor and the ground voltage;
wherein the bandgap reference voltage generator generates a reference voltage at the drain electrode of fourth transistor; and a size of the first transistor is greater than a size of the second transistor; or a size of the third transistor is smaller than a size of the fourth transistor.

8. The bandgap reference voltage generator of claim 7, further comprising:
a fourth resistor, coupled between the source electrode of the third transistor and the supply voltage; and
a fifth resistor, coupled between the source electrode of the fourth transistor and the supply voltage.

9. The bandgap reference voltage generator of claim 7, wherein resistance of the first resistor combined with the second resistor is greater than resistance of the third resistor.

10. The bandgap reference voltage generator of claim 7, wherein the first transistor and the second transistor are N-type Metal Oxide Semiconductor Field Effect Transistors (MOSFETs), and the third transistor and the fourth transistor are P-type MOSFET.

11. The bandgap reference voltage generator of claim 7, further comprising:
a buffer, configured to receive the reference voltage to generate an adjusted reference voltage, and the buffer comprises:
an operational amplifier, wherein a first input terminal is used to receive the reference voltage;
a trimming circuit, wherein an input terminal of the trimming circuit is connected to a second input terminal of the operational amplifier, and the trimming circuit is configured to generate adjusted reference voltage; and
a transistor, controlled by a signal outputted by the operational amplifier, to selectively connecting the supply voltage to the trimming circuit.

12. The bandgap reference voltage generator of claim 11, wherein the operational amplifier further comprises a tracker, and the tracker is configured to control the signal outputted by the operational amplifier to be a complementary-to-absolute temperature (CTAT) voltage.
